(19) United States
(12) Patent Application Publication
(10) Pub. No.: US 2023/0291032 A1
(43) Pub. Date: Sep. 14, 2023

(54) DEVICE FOR COOLING TWO ELECTROCHEMICAL CELLS, CORRESPONDING ELECTROCHEMICAL ASSEMBLY AND METHOD

(71) Applicant: TotalEnergies OneTech, COURBEVOIE (FR)

(72) Inventors: Nicolas OBRECHT, SAINTE FOY LÈS LYON (FR); Clément HUMBERT, SAINT-ETIENNE (FR); Alexandre NARBONNE, BLANQUEFORT (FR); Floriane LE FUSTEC, BORDEAUX (FR)

(73) Assignee: TotalEnergies OneTech, COURBEVOIE (FR)

(21) Appl. No.: 18/019,279

(22) PCT Filed: Aug. 5, 2021
(86) PCT No.: PCT/EP2021/071860

§ 371 Date: Feb. 2, 2023

(30) Foreign Application Priority Data
Aug. 6, 2020 (FR) 20 08321

(51) Int. Cl. H01M 10/6568; H01M 10/613

(52) U.S. Cl. CPC H01M 10/6568; H01M 10/613

(57) ABSTRACT

A device for cooling two adjacent electrochemical cells, characterized in that the cooling device comprises a cooling body provided with a first body face suitable for being in contact with a first electrochemical cell and a second body face suitable for being in contact with a second electrochemical cell, and with a cooling channel suitable for containing a cooling liquid. The cooling channel has first open channel sections which are suitable for being closed by a wall of the first electrochemical cell and the cooling channel comprises second open channel sections which are suitable for being closed by a wall of the second electrochemical cell.

### CROSS REFERENCE TO RELATED APPLICATIONS

The present application is a U.S. National Phase Application under 35 U.S.C. §371 of International Patent Application No. PCT/EP2021/071860 filed Aug. 5, 2021, which claims priority of French Patent Application No. 20 08321 filed Aug. 6, 2020. The entire contents of which are hereby incorporated by reference.

### FIELD OF THE INVENTION

The present invention relates to a device for cooling two adjacent electrochemical cells.

### BACKGROUND

Devices for cooling electrochemical cells are known, which are used for managing the temperature of electrochemical cells.

A cooling device is known from the patent application IN 201841043026 (application number).

In the field of electrochemical cells such as Li-lon cells, it is known that the temperature of the cells has to be managed in order to maintain the temperature within an adequate range of the cell.

### SUMMARY

The purpose of the invention is to propose a cooling device for efficiently managing the temperature of two electrochemical cells, using economical means. A further subject matter of the invention is to propose an efficient thermal management device for electrochemical cell modules. Moreover, the device should be reliable and have small bulk and low weight. Furthermore, the problem of thermal runaway of Li-lon cells is known. Such phenomenon occurs when an electrochemical cell reaches a determined critical temperature, which leads to heating of a neighboring cell to a critical temperature. A further subject matter of the invention is to reduce the risk of thermal runaway, in particular within an electrochemical module or a group of cells.

To this end, the subject matter of the invention is a cooling device as indicated above, characterized in that the cooling device comprises:
a cooling body provided with
   a first face of the body suitable for being in contact with a first electrochemical cell and
   a second face of the body suitable for being in contact with a second electrochemical cell,
   a cooling channel suitable for containing a cooling liquid;
the cooling channel including first open channel sections which are suitable for being closed by a wall of the first electrochemical cell and
the cooling channel including second open channel sections suitable for being closed by a wall of the second electrochemical cell.

According to particular embodiments of the cooling device, the latter can have one or a plurality of the following features:
the cooling channel defines a direction of flow (S) of the cooling fluid and includes, along the direction of flow, alternatingly, the first open channel sections and the second open channel sections, and the first open channel sections and the second open channel sections being linked by closed connecting channel sections;
the cooling body comprises a contact plate and a connecting plate, the contact plate forming the first body face, the second body face, the first open channel sections and the second open channel sections, and the connecting plate forming the connecting channel sections as well as, preferentially, an inlet and an outlet for a cooling liquid;
the first open channel sections and the second open channel sections are formed by through grooves provided in the contact plate, the through grooves being covered by the connecting plate, and/or the connecting sections being formed by closed grooves provided in the connecting plate;
the first open channel sections and/or the second open channel sections are substantially U-shaped, and in particular the substantially U-shaped open channel sections are arranged side by side or are nested one within the other;
the cooling device comprises a buffer housing comprising a thermal buffer of phase-change material, in particular the buffer housing being formed by a stepped portion of the connecting plate.

A further subject matter of the invention is an electrochemical assembly, of the type comprising
a first electrochemical cell having a first housing provided with a first wall,
a second electrochemical cell with a second housing provided with a second wall,
   characterized in that the electrochemical assembly comprises a cooling device as defined above, in that
   the first wall covers the first open channel sections, in that
   the second wall covers the second open channel sections, and in that
   the channel sections covered by the first and second walls and the connecting channel sections form a cooling circuit.

According to particular embodiments of the assembly, the assembly can have one or a plurality of the following features:
the first wall and the second wall are the large faces of the first housing and of the second housing, respectively; and
the cooling circuit contains a cooling fluid which is a dielectric fluid, in particular a dielectric liquid.

The invention further relates to a method for cooling an electrochemical assembly, characterized in that the electrochemical assembly is an electrochemical assembly as defined above, and in that the method comprises making a cooling liquid flow through the cooling circuit,
by cooling the first electrochemical cell and heating the cooling liquid, and
by heating the second electrochemical cell at least partially with the thermal energy of the cooling liquid received from the first electrochemical cell.

### BRIEF DESCRIPTION OF THE DRAWINGS

The invention will be better understood upon reading the following description, given only as an example and making reference to the enclosed drawings, wherein:

FIG. 1 shows a perspective view of a battery according to the invention, comprising a multitude of electrochemical cells and a multitude of cooling devices;

FIG. 2 shows a perspective view on a larger scale of a part of the battery shown in FIG. 1, comprising four cells and two cooling devices according to the invention;

FIG. 3 shows schematically a plan view of the part of the battery shown in FIG. 2;

FIG. 4 shows a perspective view of the contact plate and of the connecting plate of a cooling device according to the invention;

FIG. 5 is a front view along of the contact plate shown in FIG. 4; and

FIG. 6 is a front view of the connecting plate shown in FIG. 4.

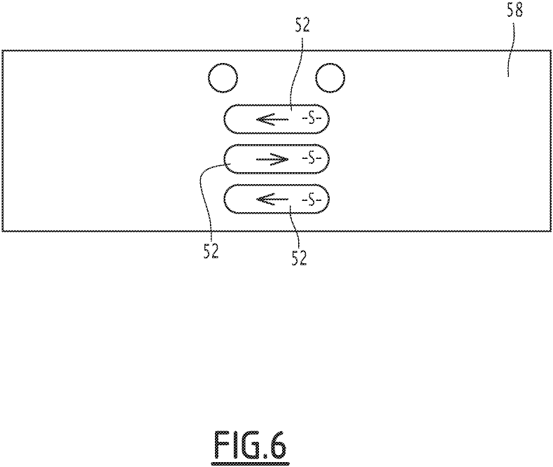

### DETAILED DESCRIPTION OF THE DRAWINGS

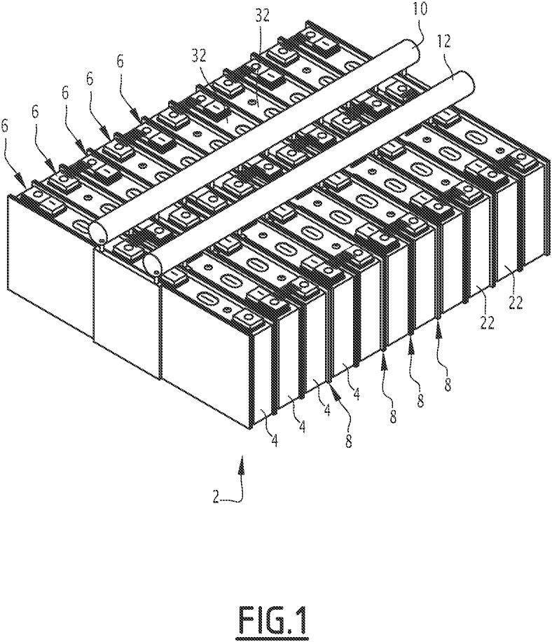

FIG. 1 shows a battery according to the invention, as indicated by the general reference 2.

The battery is an electrochemical battery such as currently used in electric vehicles. However, other fields of application of the battery 2 are envisaged.

The battery 2 comprises a multitude of first electrochemical cells 4 and of second electrochemical cells 6 and a multitude of cooling devices 8. The battery 2 further comprises an outbound manifold 10 and a return manifold 12 for the cooling liquid.

The battery 2 comprises a multitude of electrochemical assemblies 20, each of which comprises a first electrochemical cell 4, a second electrochemical cell 6 and a cooling device 8.

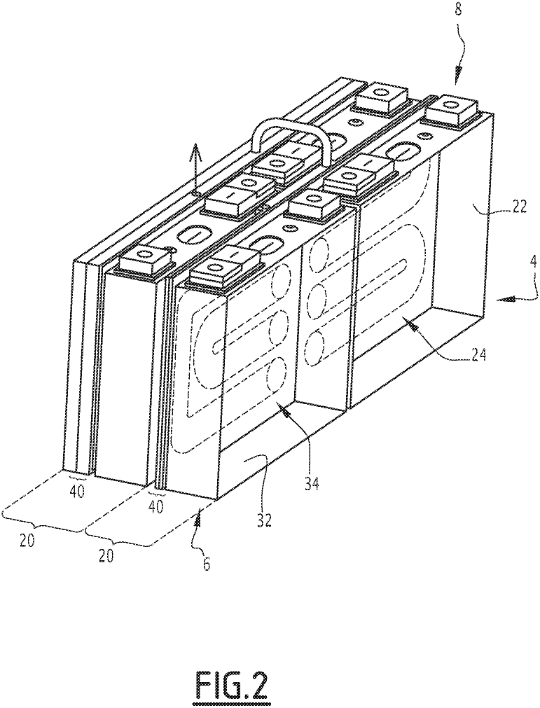

Each first electrochemical cell 4 comprises a first housing 22 which is substantially parallelepipedal, and which forms a first flat wall 24. The first wall 24 forms the large face of the parallelepiped formed by the first housing 22. The first electrochemical cell 4 comprises conventional electrochemical elements, e.g. Li-ion elements, and contacts on the upper face thereof (FIG. 2).

Each second electrochemical cell 6 comprises a second housing 32 which is substantially parallelepipedal, and which forms a second flat wall 34. The second wall 34 forms the large face of the parallelepiped formed by the second housing 32. The second electrochemical cell 6 comprises conventional electrochemical elements, e.g. Li-ion elements, and contacts on the upper face thereof.

The first electrochemical cell 4 and the second electrochemical cell 6 are adjacent. Within the framework of the present invention, the above means that the first housing 22 and the second housing 32 are arranged in such a way that the small faces thereof face each other. Furthermore, the first housing 22 and the second housing 32 are arranged side by side in such a way that the first and second walls 24, 34 are coplanar.

The cooling device 8 is suitable for cooling the first electrochemical cell 4 and the second electrochemical cell 6 of an electrochemical assembly 20. The cooling device 8 is further suitable for transmitting a portion of the heat from the first electrochemical cell 4 to the second electrochemical cell 6 and vice versa.

To this end, the cooling device 8 is suitable for making the cooling fluid flow from a heat-receiving zone, e.g. from the first electrochemical cell 4, to a heat-returning zone, e.g. of the second electrochemical cell 6.

The cooling device 8 comprises a cooling circuit 36 which contains the cooling fluid, which is a dielectric fluid. Hence, the cooling fluid is a heat-transfer fluid.

Dielectric fluid refers to any fluid, hence any gas or liquid, which can sustain a static electric field and act as an electrical insulator. Examples of dielectric fluids suitable for the present invention can comprise, but are not limited to, any dielectric fluid resistant to ignition and/or non-flammable. More particularly, the dielectric fluid resists ignition at least up to a maximum temperature which can appear in the electrochemical cell, which is e.g, the minimum thermal runaway temperature.

Examples of dielectric fluids which can be used in the context of the present invention, but are not limited to, are the dielectric fluids which are already used in all the constituent parts of the power train of a motor vehicle, more particularly the power train of a hybrid or electric vehicle, such as the motor, the power electronic system, the reduction gear, or again and preferentially at the battery. The dielectric fluids which can be used within the framework of the present invention are e.g. produced from paraffinic oils, silicone oils, or synthetic organic esters. The dielectric fluids which can be used within the framework of the present invention, and which are based on mineral oils, are very conventionally used because of the availability thereof, the low cost thereof and the physical properties thereof such as the property of being characterized by good thermal properties.

For this purpose, the cooling device 8 comprises a cooling body 40 provided
with a first body face 42 suitable for being in contact with the first electrochemical cell 4, more precisely for being in contact with the first housing 22,
a second body face 44, suitable for being in contact with the second electrochemical cell 6, more precisely for being in contact with the second housing 32, and
a cooling channel 46 suitable for containing the cooling liquid.

The cooling channel 46 includes first channel sections 48 formed in the first face of the body 42 and open, which are suitable for being closed by a wall of the first electrochemical cell 4.

The cooling channel 46 includes second channel sections 50 provided in the second face of the body 44 and open, which are suitable for being closed by a wall of the second electrochemical cell 6.

The first open channel sections 48 and the second open channel sections 50 are connected by closed connecting channel sections 52. The connecting channel sections 52 span the interstice between the two adjacent electrochemical cells.

The cooling channel 46 defines a direction of flow S of the cooling fluid and includes, along the direction of flow S, alternatingly, the first open channel sections, the second open channel sections and closed connecting channel sections 52.

The cooling body 40 comprises a contact plate 56 and a connecting plate 58.

The contact plate 56 forms the first body face 42, the second body face 44, the first open channel sections 48 and the second open channel sections 50.

The first channel sections 48 and the second channel sections 50 are formed by through-grooves provided in the contact plate 56, i.e. the grooves run through the thickness of the contact plate 56.

Such through grooves are covered on one side by the connecting plate 58 and on the other side by the housing of the associated electrochemical cell 4, 6. When the cooling liquid flows through the first open channel sections 48 and second open channel sections 50, same is thus in contact with the housing, and the wall of the housing of the associated electrochemical cell 4, 6, respectively.

In the present case, the contact plate 56 has a rectangular outer contour. The contact plate 56 is, in the present case, a single piece and in one piece.

The contact plate 56 is made of a relatively flexible material, i.e. suitable for making the interface between the faces of the body 42, 44 and the electrochemical cells on one side and between the surface of the contact plate and the connecting plate 58 on the other side, liquid-tight with regard to the cooling liquid, by means of compressing the cooling body 40 between a pair of two electrochemical cells 4, 6 and a pair of two neighboring electrochemical cells 4, 6.

Moreover, the material of the contact plate 56 is resistant to high temperatures (temperature range) and to an aggressive chemical environment. Such a material is e.g. marketed under the trade name “COGEMICA HT 710”. The material is e.g. made of Mica powder + silicone. Other materials can be used for such purpose.

Generally, the material of the contact plate 56 is more flexible or elastic than the material of the housing 22, 32 and of the connecting plate 58.

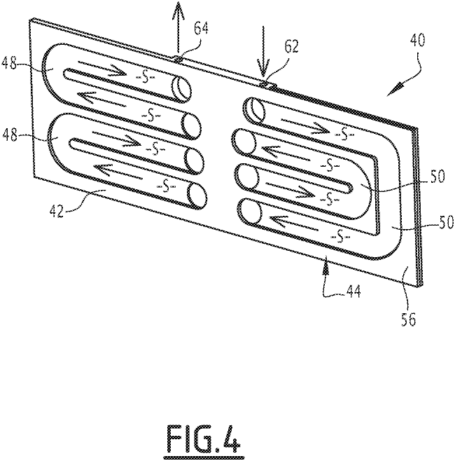

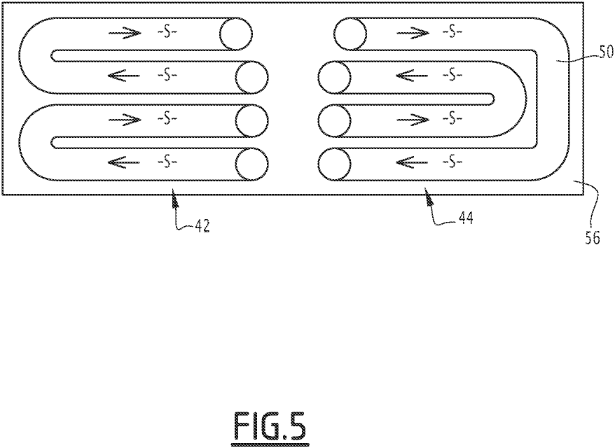

Advantageously, the first channel sections 48 and/or the second channel sections 50 are substantially U-shaped (see FIGS. 4 and 5). In particular, the substantially U-shaped channel sections are arranged side by side or are nested one inside the other. In such case, the first channel sections 48 are arranged side by side with the open end of the “U” directed towards the second channel sections 50. On the other hand, the second channel sections 50 are arranged nested one inside the other with the open end of the “U” directed towards the first channel sections 48.

The connecting plate 58 includes a connecting face 60 which is in sealed contact with the contact plate 56, on the side opposite the body faces 42, 44.

The connecting plate 58 forms the connecting channel sections 52 as well as, preferentially, a cooling liquid inlet 62 and a cooling liquid outlet 64. The cooling liquid inlet 62 is connected to the supply manifold 10 and the cooling liquid outlet 64 is connected to the return manifold 12.

The connecting channel sections 52 are formed by closed or blind grooves provided in the connecting plate 58. The connecting channel sections 52 are closed by the contact plate and are in fluidic communication at the ends thereof. When the cooling liquid flows through the connecting channel section 52, same is in contact with the connecting plate 58 and with the contact plate 56, but not with the housing of the electrochemical cells 4 and 6.

The connecting plate 58 is made of a harder material than the material of the contact plate 56, and is made of e.g. of aluminum.

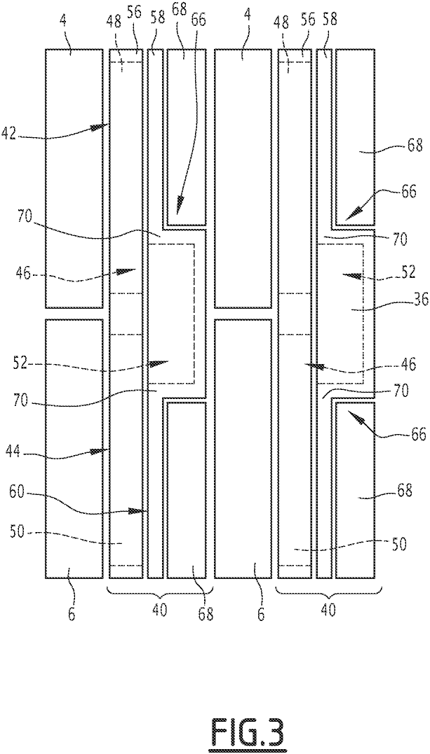

The cooling device 8 can further comprise at least one buffer housing 66 comprising a thermal buffer 68, in particular comprising a phase-change material (PCM). The buffer housing 66 is, in the present case, formed by a stepped portion 70 of the connecting plate 58. Advantageously, and as shown in FIG. 3, the connecting plate 58 includes two stepped parts 70 which are disposed on either side of the connecting channel sections 52. In the present case, the cooling device includes two thermal buffers 68.

The thermal buffers 68 are out of contact with the cooling liquid and are applied on one side to the connecting plate 58 and on the other side to one of the housings 22, 32 of the electrochemical cells. The phase-change material of the thermal buffer 68 comprises e.g. an organic material, such as a polymer, a wax or an oil. The transition temperature of the phase-change material is e.g. between 25° C. and 35° C. The material can also be a material marketed by the company Hutchinson under the name “PCsMart”.

An example of an embodiment of a cooling device according to the subject matter of the present description or invention includes the following parameters:

The thickness of the connecting plate 56 is 1.5 mm and can be comprised between 1 mm and 2 mm.

The height of the cooling channels 48 is 16 mm and can be comprised between 5 mm and 20 mm, preferentially between 15 mm and 20 mm. The combined height of all cooling channels is e.g. at least 70% of the height of the connecting plate.

The cooling channel 46 is provided with exactly two first channel sections 48 and with two second channel sections 50.

The present example shows a good compromise between fluid head loss and cooling capacity.

The cooling device is used as follows: a cooling fluid or a heat-transfer fluid is made flow through the cooling circuit by cooling the first electrochemical cell 4 and by heating the cooling fluid or heat-transfer fluid. The cooling fluid or heat-transfer fluid then heats the second electrochemical cell 6 and the heat buffer 68 through the connecting plate 58, at least partially with the heat energy that the cooling liquid or heat transfer-fluid has received from the first electrochemical cell 4.

In general, the heat-transfer fluid can exchange calories with the cells 4, 6 with which same is in contact so as to cool or heat the cells (as required). Moreover, the heat-transfer fluid is temperature-regulated in a circuit external to the battery and not described herein. Advantageously, one mode of operation makes it possible to limit the excessive heating of a cell by distributing the thermal energy of said cell over the other elements, which will serve as heat sinks. The heat-transfer fluid e.g. can cool a cell 4 which would be in a phase of abnormal heating, by absorbing heat and then giving up the heat thereof to the cell 6, the connecting plate 58 and the thermal buffers 68.

The foregoing description contains technical features of the invention. Such technical features, although presented in a technical context and, if appropriate, in combination with other technical features, can be used every time individually, without the other technical features, insofar as technically possible.

1. A cooling device for two adjacent electrochemical cells, characterized in that the cooling device comprises:
a cooling body comprising:
a first body face being in contact with a first electrochemical cell; and
a second body face being in contact with a second electrochemical cell,
a cooling channel containing a cooling liquid; wherein:
the cooling channel comprises first open channel sections which are suitable for being closed by a wall of the first electrochemical cell, and
the cooling channel comprises second open channel sections suitable for being closed by a wall of the second electrochemical cell.

2. The cooling device according to claim 1, wherein the cooling channel defines a direction of flow of the cooling liquid and includes, along the direction of flow, alternately the first open channel sections and the second open channel sections, and wherein the first open channel sections and the second open channel sections are connected by closed connecting channel sections.

3. The cooling device according to claim 2, wherein the cooling body comprises a contact plate and a connecting plate, wherein
the contact plate forms the first body face, the second body face, the first open channel sections and the second open channel sections, and wherein
the connecting plate forms the connecting channel sections.

4. The cooling device according to claim 3, wherein the first open channel sections and the second open channel sections are formed by through grooves provided in the contact plate, the through grooves being covered by the connecting plate, or the connecting sections are formed by closed grooves provided in the connecting plate.

5. The cooling device according to claim 1, wherein the first open channel sections or the second open channel sections are substantially U-shaped.

6. The cooling device according to claim 1, wherein the cooling device comprises a buffer housing comprising a thermal buffer made of phase-change material.

7. An electrochemical assembly comprising:
a first electrochemical cell having a first housing provided with a first wall,
a second electrochemical cell having a second housing provided with a second wall,
characterized in that the electrochemical assembly comprises a cooling device according to claim 1, in that
the first wall covers the first open channel sections, in that
the second wall covers the second open channel sections, and in that
the channel sections covered by the first and second walls and the connecting channel sections form a cooling circuit.

8. The electrochemical assembly according to claim 7, wherein the first wall and the second wall are the large faces of the first housing and the second housing, respectively.

9. The electrochemical assembly according to claim 7, wherein the cooling circuit contains a cooling fluid which is a dielectric fluid.

10. A method of cooling an electrochemical assembly, characterized in that the electrochemical assembly is an electrochemical assembly according to claim 7, and in that the method comprises circulating cooling liquid through the cooling circuit,
by cooling the first electrochemical cell and heating the cooling liquid, and
by heating the second electrochemical cell at least partially with the thermal energy of the cooling liquid received from the first electrochemical cell.

11. The cooling device according to claim 3, wherein the connecting plate forms an inlet and an outlet for the cooling liquid.

12. The cooling device according to claim 5, wherein the substantially U-shaped open channel sections are arranged side by side or are nested one inside the other.

13. The cooling device according to claim 6, wherein the buffer housing is formed by a stepped portion of the connecting plate.

14. The electrochemical assembly according to claim 9, wherein the cooling fluid is a dielectric liquid.
